(19) United States
(12) Patent Application Publication
(10) Pub. No.: US 2024/0148482 A1
(43) Pub. Date: May 9, 2024

(54) DENTAL APPARATUS AND METHOD OF USING THE SAME

(71) Applicant: Terry Joldersma, Mears, MI (US)

(72) Inventor: Terry Joldersma, Mears, MI (US)

(21) Appl. No.: 18/414,795

(22) Filed: Jan. 17, 2024

Related U.S. Application Data
(63) Continuation-in-part of application No. 17/166,365, filed on Feb. 3, 2021.

(51) Int. Cl. A61C 15/04

(52) U.S. Cl. CPC A61C 15/046

(57) ABSTRACT

A dental apparatus that enables a user to controllably dispense one or more fluids during normal operation, including: a body, wherein the body includes a handle member and a flossing head; a floss member associated with the flossing head; and a fluid containing reservoir, wherein the fluid containing reservoir includes a fluid dispensing aperture proximate the floss member.

### CROSS-REFERENCE TO RELATED APPLICATIONS

This application is a continuation-in-part of U.S. application Ser. No. 17/166,365, entitled “DENTAL APPARATUS AND METHOD OF USING THE SAME,” filed Feb. 3, 2021—all of which is hereby incorporated herein by reference in its entirety, including all references cited therein.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to dental apparatuses and, more particularly, to dental apparatuses that enable a user to controllably dispense one or more fluids (e.g., mouthwash, breath freshener, teeth whitening agent, anti-cavity agent, desensitizing agent, pain killer, antibiotic, medicament, etcetera) during normal operation of the same. The present invention further relates to methods of using dental apparatuses to controllably deliver one or more fluids to a desired location by the user.

### 2. Background Art

Dental apparatuses have been known in the art for years and are the subject of a plurality of patents and publications, including: U.S. Pat. No. 9,930,957 entitled “Dental Devices with Liquid Applicator,” U.S. Pat. No. 8,668,493 entitled “Liquid Interdental Cleaner,” U.S. Pat. No. 6,957,958 entitled “Unit Dose Applicator with Material Chamber,” U.S. Pat. No. 5,908,257 entitled “Toothpaste Dispensing Toothbrush,” U.S. Pat. No. 5,906,213 entitled “Flossing Device and Method of Use,” U.S. Pat. No. 5,365,956 entitled “Toothbrush and Dental Floss Holder,” U.S. Pat. No. 5,346,324 entitled “Dentifrice Dispensing Toothbrush with Replaceable Cartridge,” United States Patent Application Publication Number 2010/0284726 entitled “Liquid Dentifrice Dispensing Toothbrush,” International Patent Application Publication Number WO 1991/007143 entitled “Dental Floss Applicators,” and Korean Patent Application Publication Number 10-1268233 entitled “Oral Care Implement Having Fluid Delivery System”—all of which are hereby incorporated herein by reference in their entirety including all references cited therein.

U.S. Pat. No. 9,930,957 (hereinafter the '957 patent) appears to disclose various dental devices that are available for cleaning the mouth, gums and teeth. However, these dental devices may also cause abrasions to the mouth and/or gums. The dental devices include a reservoir for storing a liquid and for application of the liquid to the mouth, teeth and/or gums. The liquid may be an antibacterial liquid, such as a hydrogen peroxide solution, a salt solution or a teeth whitening solution or gel, for example. An antibacterial liquid may be applied to prevent infection of the abrasions. The reservoir may be in a hollow handle of the dental device, such that the liquid may be easily pumped or moved from the reservoir to an outlet at the functional end that may cause the abrasions. As is shown in FIG. 1, the dental pick disclosed in the '957 patent dispenses liquid from the top of the functional end of the dental pick instead of to or proximate the floss itself.

U.S. Pat. No. 8,668,493 appears to disclose an interdental cleaner that includes a source of liquid and a control system including a manual pump, for moving a selected amount of liquid, suitable for a single use, into a liquid pathway and there to a mixing chamber. A source of pressurized gas, such as a CO₂ cartridge, is used to preload a selected amount of gas into a gas chamber. The control system includes a spring-loaded button, which upon operation results in the manual pump being operated, forcing the selected amount of liquid into the mixing chamber, and then upon release, permits the pressurized gas in the gas chamber to enter the mixing chamber, breaking up the liquid therein into droplets and a liquid stream, and propelling the resulting liquid out of a nozzle portion of the cleaner into the interproximal area of the teeth.

U.S. Pat. No. 6,957,958 appears to disclose an applicator having an applicator end portion and a material end portion. The material end portion forms a container holding a material to be applied with the applicator end portion. Upon separating the material end portion from the handle portion of the applicator, a container is formed which is used to dip the applicator into the end portion of the applicator. The present invention is particularly applicable to the dispensing of medicaments, and in particular, dental materials. A single dose of material is integrally formed within the applicator and sealed until ready for use.

U.S. Pat. No. 5,908,257 appears to disclose a toothbrush that is adapted to contain a significant quantity of toothpaste therein and to dispense the toothpaste onto the toothbrush bristles. The toothbrush generally comprises a hollow handle having a brush head formed integrally on its top end, a disposable toothpaste containing cartridge supported within its interior, and a piston mechanism threadably attached to its bottom end. The piston mechanism is adapted to force the toothpaste out of the handle into a conduit formed through the brush head. The conduit leads from the interior of the handle to a plurality of outlet holes disposed below resilient valves in a rubber gasket layer which supports the bristles. The valves allow toothpaste to flow from the conduit onto the bristles of the toothpaste while preventing water or other fluids from flowing into the conduit to contaminate the toothpaste supply.

U.S. Pat. No. 5,906,213 appears to disclose a dental cleaning tool that has a handle, a base, a floss stem, and a supply of dental floss. The dental floss is contained within the base and a supply of fluid is contained within the handle. The base and the handle removably engage each other, frictionally clamping one end of the dental floss therebetween. Both the fluid and the other end of the dental floss exit through a fluid ejection conduit of the base. The floss is removably engaged to a floss locking tip near the terminal end of the floss stem, allowing the user to utilize the dental floss to clean his teeth. While flossing his teeth, the user can squeeze the handle and spray fluid, such as mouth wash, down the length of the dental floss and into his mouth.

U.S. Pat. No. 5,365,956 appears to disclose a toothbrush having a spool of floss that is stored within the handle and a floss holding frame for holding a portion of the floss in a taut condition for use thereof. The toothbrush includes a handle which terminates in a floss holding frame across which floss from the spool may be extended and held tight. The floss spool and the floss holding frame are longitudinally arranged such that a protective cover may be placed thereover.

U.S. Pat. No. 5,346,324 appears to disclose a dentifrice dispensing toothbrush which utilizes a compressible elastic button to pump a controlled quantity of dentifrice material from a replaceable cartridge to the brush head. The toothbrush locks itself to prevent further pumping of dentifrice material when its replaceable cartridge is nearly empty. The self-locking mechanism eliminates the formation of voids in the dentifrice material and consequent pump failure when the spent cartridge is replaced. In one embodiment, a cover is provided which protects the brush head, bristles, pumping mechanism and other parts of the toothbrush. The cover also seals the conduit which supplies dentifrice material to the brush head to prevent it from becoming clogged with dried dentifrice material during periods of non-use and to prevent accidental compression of the button. The compressible elastic button is part of a pump assembly which also includes a pump chamber, a partition which divides the pump chamber into an intake compartment and a discharge compartment, a one way check valve for an opening in the base of the pump chamber to control the flow of dentifrice material from the cartridge to the pump chamber and an opening in the partition between the intake and discharge compartments. A plug is attached to the top of a follower disc which is positioned in the cartridge. When the cartridge is nearly depleted, the plug locks the toothbrush by blocking the dispensing movement of the dentifrice material.

United States Patent Application Publication Number 2010/0284726 appears to disclose a dentifrice dispensing toothbrush for applying a predetermined measured amount of liquid dentifrice from a reservoir of liquid dentifrice into the toothbrush bristles by means of an in integral pump. Liquid dentifrice may be refilled using the handle portion of the toothbrush.

International Patent Application Publication Number WO 1991/007143 appears to disclose a dental floss applicator that comprises a casing to hold a container of dental floss and a pressure activated container of flowable medication or freshness agent. The casing is in two parts, a body portion and a sleeve, the sleeve being slidable relative to the body portion. The body portion holds the containers and has a neck and head portion. The sleeve is relatively slidable towards the head to cause pressure activation and discharge of a controlled small metered dose of agent from outlets in the head into floss carried by pronged arms on the head. Floss is drawn from the container, along the neck to the head then back along the neck to a securing means on the sleeve so that when the sleeve is drawn away from the head a fresh length of floss is drawn onto the head to lie between pronged arms. The lengths of floss upstream and downstream of the head pass under a hinged clamp which tensions the floss or releases the floss to enable the sleeve to draw in a fresh length of floss.

Korean Patent Application Publication Number 10-1268233 appears to disclose an oral care implement that includes a head having a tooth cleaning element on one surface and a reservoir holding at least one active agent. The capillary channel extends through at least a portion of the oral care implement to dispense the active agent(s) to one or more outlets. According to one feature, a vibration generating device is provided that vibrates at least a portion of the instrument to enhance the function of the tooth cleaning element and the distribution of the active agent through capillary action. Various active agents may be administered for treatment, hygiene, and/or other benefits such as fresh breath and teeth whitening or the creation of hot and cold and bitterness.

While the above-identified patents and publications do appear to disclose various dental apparatuses, their configurations remain non-desirous and/or problematic inasmuch as, among other things, none of the above-identified dental apparatuses appear to enable a user to controllably dispense one or more fluids to a predetermined location during normal operation of the same.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a dental apparatus that enables a user to controllably dispense one or more fluids during normal operation comprising, consisting essentially of, and/or consisting of: (a) a body, wherein the body includes a handle member and a flossing head; (b) a floss member associated with the flossing head; and (c) a fluid containing reservoir, wherein the fluid containing reservoir includes a fluid dispensing aperture proximate the floss member.

In a preferred embodiment of the present invention, the handle member includes a proximal end, a distal end, a top surface, a bottom surface, a left-side surface, and a right-side surface.

In another preferred embodiment of the present invention, the proximal end of the handle member includes a dental pick.

In yet another preferred embodiment of the present invention, the handle member includes a compressible elastic member that forms part of the fluid containing reservoir.

In one embodiment of the present invention, the flossing head includes a top surface, a bottom surface, a left-side surface, and a right-side surface.

In a preferred embodiment of the present invention, the flossing head includes a first arm having a fluid dispensing aperture and a second arm having a fluid dispensing aperture.

In yet another preferred embodiment of the present invention, the first arm and the second arm form part of the fluid containing reservoir.

In one preferred aspect of the present invention, a breakable seal is positioned proximate the fluid dispensing apertures of the first and second arms.

In a preferred embodiment of the present invention, the fluid dispensing apertures of the first and second arms are positioned proximate to, above, and optionally below the floss member.

In another preferred embodiment of the present invention, the floss member is secured on a first end within the first arm and on a second end within the second arm.

In yet another preferred embodiment of the present invention, the floss member comprises unwaxed floss, waxed floss, dental tape, nylon floss, polytetrafluorethylene floss, wood, plastic, metal, and/or combinations thereof.

In a preferred embodiment of the present invention, the fluid contained within the fluid containing reservoir comprises a low viscosity liquid (i.e., 1-999 centipoise (cps)), a medium viscosity liquid/fluid (i.e., 1,000-99,999 cps), a high viscosity liquid/fluid (i.e., 100,000-500,000+ cps), a gel, and/or combinations thereof.

In yet another preferred embodiment of the present invention, the fluid contained within the fluid containing reservoir comprises mouthwash, breath freshener, a teeth whitening agent, an anti-cavity agent, a desensitizing agent, a pain killer, an antibiotic, a medicament, and/or combinations thereof.

The present invention is also directed to a dental apparatus that enables a user to controllably dispense one or more fluids during normal operation, comprising, consisting essentially of, and/or consisting of: (a) a body, wherein the body includes a handle member and a flossing head; (b) a floss member associated with the flossing head; (c) a fluid containing reservoir, wherein the fluid containing reservoir includes a fluid dispensing aperture proximate the floss member; (d) wherein the handle member includes a proximal end, a distal end, a top surface, a bottom surface, a left-side surface, and a right-side surface, wherein the proximal end of the handle member includes a dental pick, and wherein the handle member includes a compressible elastic member that forms part of the fluid containing reservoir; (e) wherein the flossing head includes a top surface, a bottom surface, a left-side surface, a right-side surface, a first arm having a fluid dispensing aperture and a second arm having a fluid dispensing aperture; (f) wherein the first arm and the second arm form part of the fluid containing reservoir; (g) wherein a breakable seal is positioned proximate the fluid dispensing aperture of the first and second arms; and (h) wherein the fluid dispensing apertures of the first and second arms are positioned proximate to, above, and optionally below the floss member.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a side view of a prior art dental apparatus disclosed in U.S. Pat. No. 9,930,957;

FIG. 2 of the drawings is a front perspective view of a dental apparatus in accordance with the present invention;

FIG. 3 of the drawings is a top view of the dental apparatus of FIG. 2;

FIG. 4 of the drawings is a bottom view of the dental apparatus of FIG. 2;

FIG. 5 of the drawings is a front view of the dental apparatus of FIG. 2;

FIG. 6 of the drawings is a rear view of the dental apparatus of FIG. 2;

FIG. 7 of the drawings is a side view of the dental apparatus of FIG. 2;

FIG. 8 is a cross-sectional view of the dental apparatus taken along line IX of FIG. 2;

FIG. 9 of the drawings is a front perspective view of a dental apparatus in accordance with the present invention, showing the dental apparatus displaced between two teeth wherein dental fluid is dispensed between the teeth and into the gums while flossing;

FIG. 10 of the drawings is a bottom view of a dental apparatus in accordance with the present invention, showing the compressible elastic member being displaced, to, in turn, dispense dental fluid from the reservoir of the dental apparatus;

FIG. 11 is an exemplary cross-sectional view of a dental apparatus of the present invention showing the dental fluid reservoir contained within the body of the dental apparatus, and further showing the fluid dispensing apertures of the first and second arms being positioned proximate to and above the floss member;

FIG. 12 of the drawings is a front perspective view of an alternative embodiment of a dental apparatus in accordance with the present invention;

FIG. 13 of the drawings is a rear perspective view of the dental apparatus of FIG. 12;

FIG. 14 of the drawings is a top view of the dental apparatus of FIG. 12;

FIG. 15 of the drawings is a bottom view of the dental apparatus of FIG. 12;

FIG. 16 of the drawings is a front view of the dental apparatus of FIG. 12;

FIG. 17 of the drawings is a rear view of the dental apparatus of FIG. 12;

FIG. 18 of the drawings is a side view of the dental apparatus of FIG. 12;

FIG. 19 is a cross-sectional view of the dental apparatus taken along line VIII of FIG. 15;

FIG. 20 is a cross-sectional view of the dental apparatus taken along line IX of FIG. 18;

FIG. 21 of the drawings is a top view (partial and exploded) of the dental apparatus of FIG. 12;

FIG. 22 of the drawings is a side view (exploded) showing four components of the dental apparatus of FIG. 12;

FIG. 23 of the drawings is a front perspective view of a dental apparatus in accordance with the present invention, showing the dental apparatus displaced between two teeth wherein dental fluid is dispensed between the teeth and into the gums while flossing; and

FIG. 24 of the drawings is a bottom view of a dental apparatus in accordance with the present invention, showing the compressible elastic member being displaced, to, in turn, dispense dental fluid from the reservoir of the dental apparatus.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

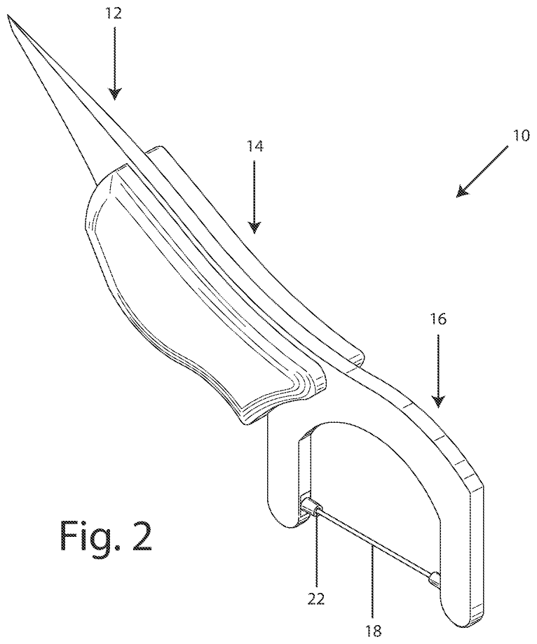

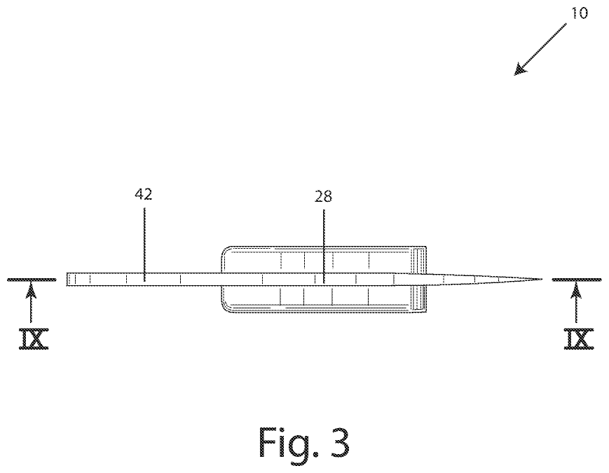

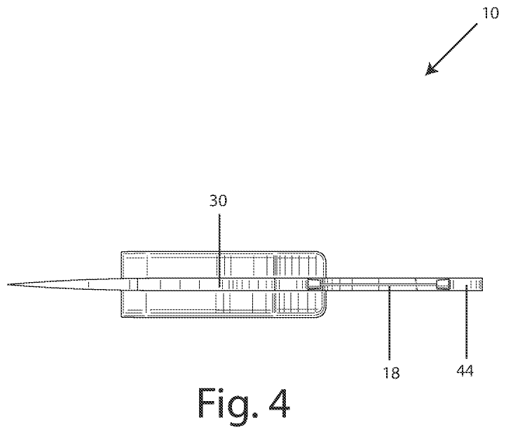

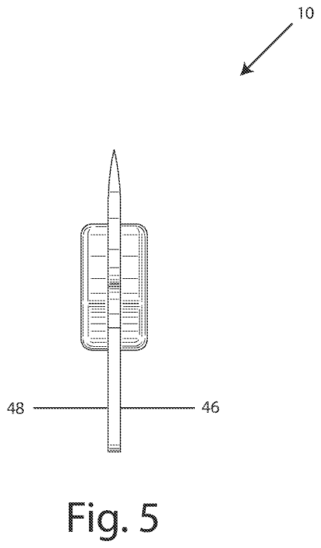

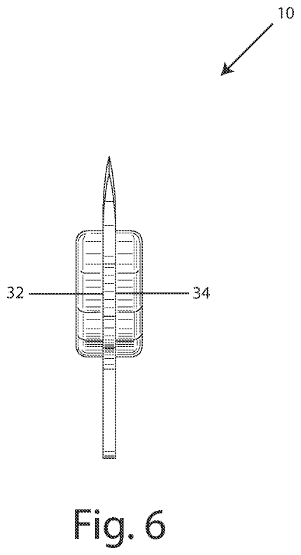

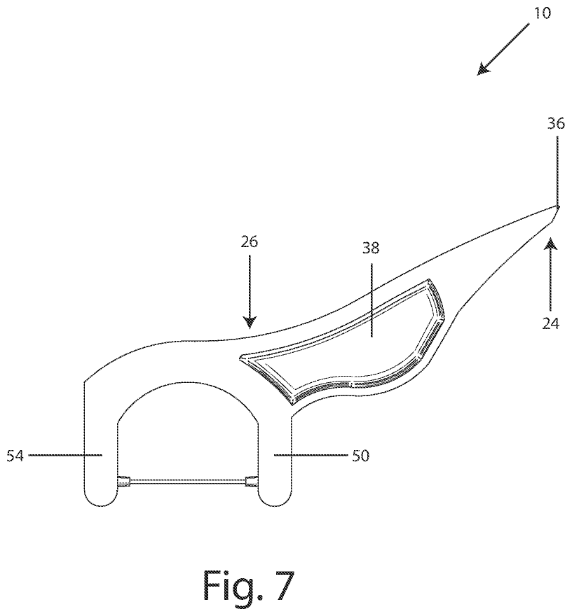

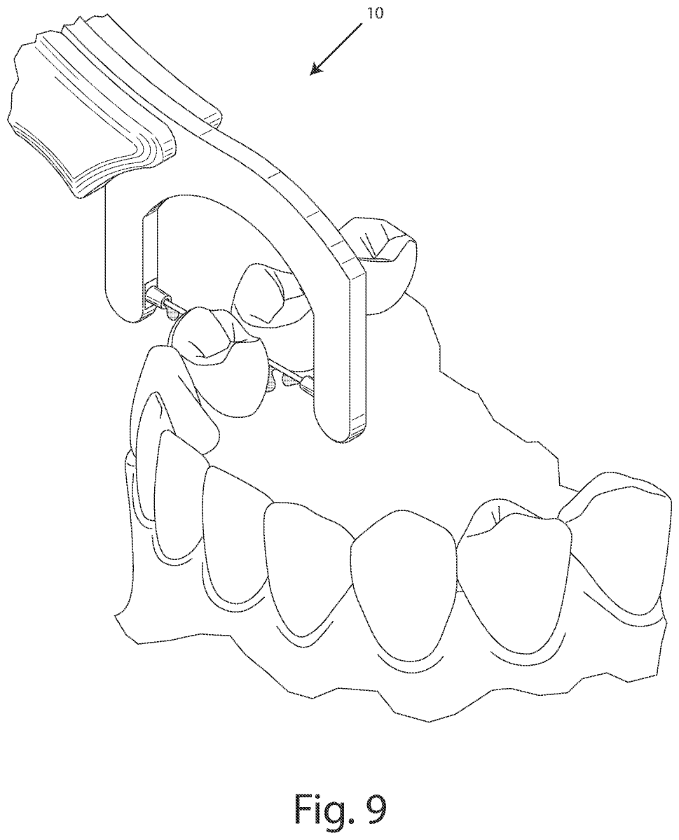

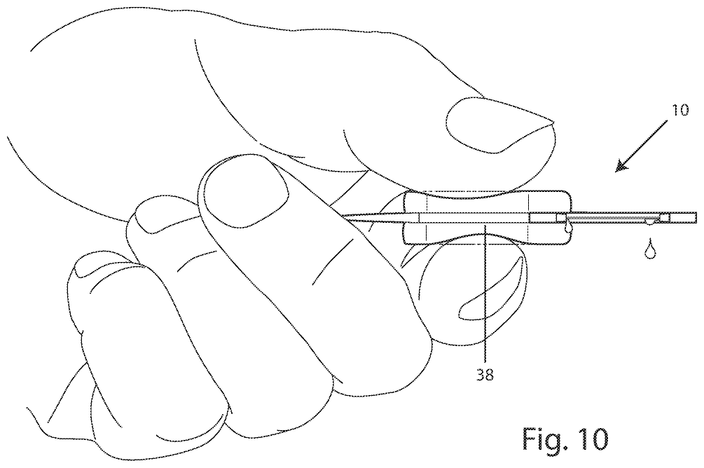

Referring now to the collective drawings, and to FIGS. 2-11 in particular, dental apparatus 10, is shown for use in association with, for example, a user's mouth, as comprising body 12 having handle member 14 and flossing head 16, floss member 18, and fluid containing reservoir 20 that includes fluid dispensing aperture 22 proximate floss member 18. Dental apparatus or flossing pick 10 enables a user to controllably dispense one or more dental fluids during normal operation (e.g., flossing, cleaning, etcetera).

Handle member 14 of body 12 preferably includes proximal end 24, distal end 26, top surface 28, bottom surface 30, left-side surface 32, and right-side surface 34. Preferably, proximal end 24 of handle member 14 includes dental pick 36.

In one embodiment of the present invention, handle member 14 includes compressible elastic member 38 that is in mechanical communication with and/or forms part of fluid containing reservoir 20. It will be understood that when displaced and/or compressed, compressible elastic member 38 dispenses dental fluid 40 from reservoir 20.

Non-limiting examples of dental fluid include low viscosity liquid (i.e., 1-999 centipoise (cps)), a medium viscosity liquid/fluid (i.e., 1,000-99,999 cps), a high viscosity liquid/fluid (i.e., 100,000-500,000+ cps), a gel, and/or combinations thereof. Specific examples include mouthwash, breath freshener, a teeth whitening agent, an anti-cavity agent, a desensitizing agent, a pain killer, an antibiotic, a medicament, and/or combinations thereof.

Flossing head 16 preferably includes top surface 42, bottom surface 44, left-side surface 46, and right-side surface 48. In one embodiment, flossing head 16 includes first arm 50 having fluid dispensing aperture 22 and second arm 54 having fluid dispensing aperture 22. Preferably, first arm 50 and second arm 54 are in mechanical communication with and/or form part of fluid containing reservoir 20.

Breakable and/or displaceable seals 56 are positioned proximate fluid dispensing apertures 22 of first and second arms 50 and 54, respectively. Seals 56 are preferably fabricated from a material that is capable of containing fluid 40 during storage and breakable and/or displaceable during use—preferably via pressure generated from compression of, for example, compressible elastic member 38. Seals 56 may optionally be scored to assist with intentional breakage, thereby allowing fluid 40 to be dispensed from reservoir 20. Non-limiting examples of suitable seal materials include wax, wax paper, plastic, wood, metal, foil, etcetera.

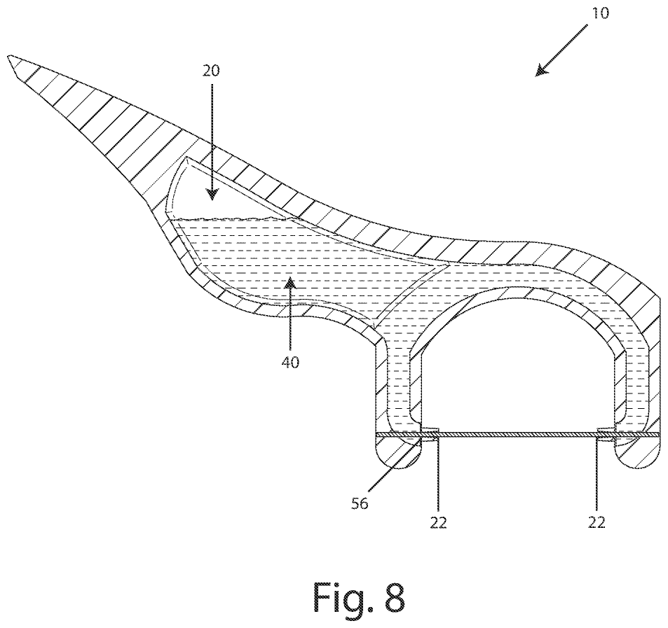

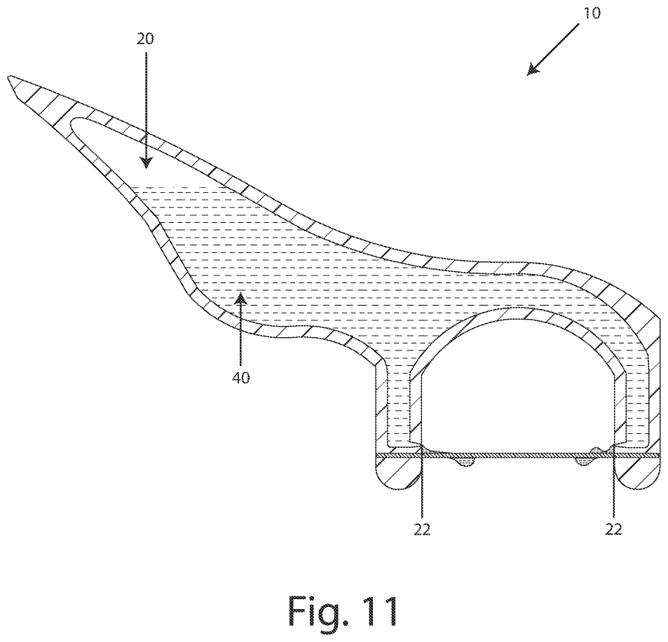

As is best shown in FIGS. 8 and 11, fluid dispensing apertures 22 of the first and second arms are positioned proximate to, above, and optionally below the floss member.

As is also best shown in FIGS. 8 and 11, floss member 18 is secured on a first end within first arm 50 and on a second end within second arm 54.

By way of non-limiting example, floss member 18 comprises unwaxed floss, waxed floss, dental tape, nylon floss, polytetrafluorethylene floss, wood, plastic, metal, and/or combinations thereof.

In operation, dental apparatus 10 is inserted between a user's teeth and optionally into the user's gum, whereby a predetermined dental fluid is controllably dispensed onto the floss and/or directly between the user's teeth and/or into the user's gums. It will be understood that dental fluid may be dispensed before or during flossing and/or other dental procedures.

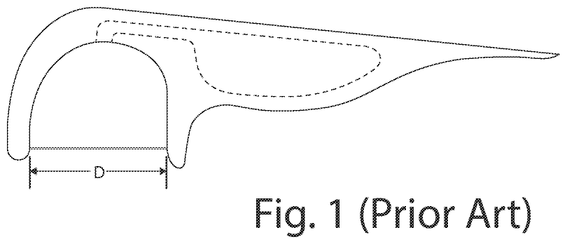

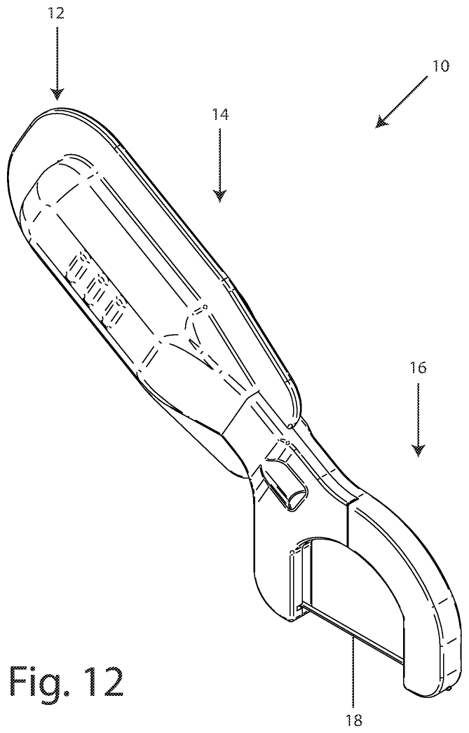

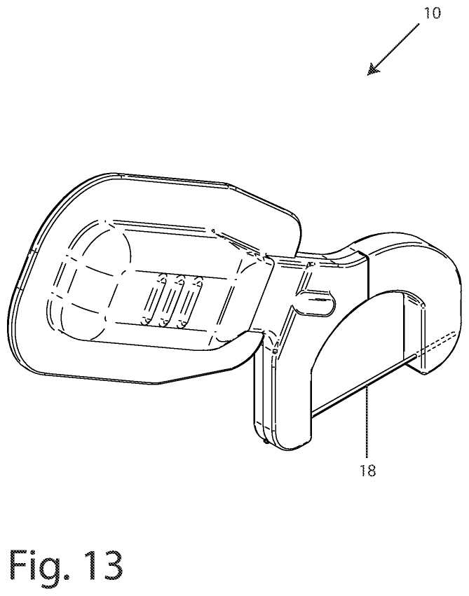

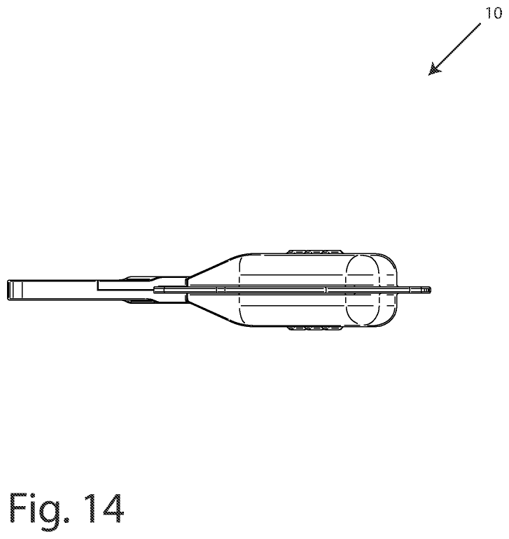

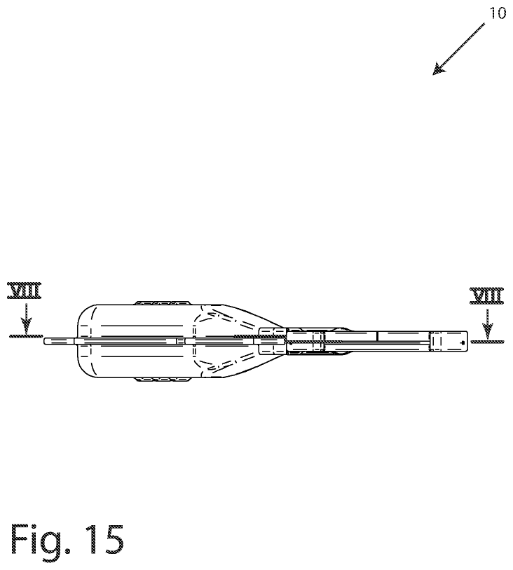

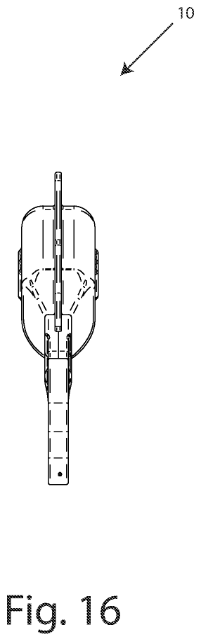

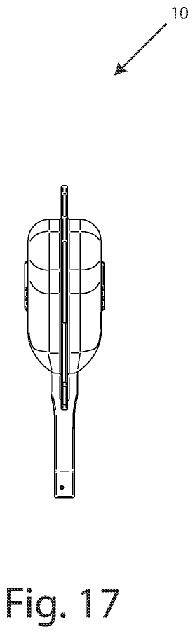

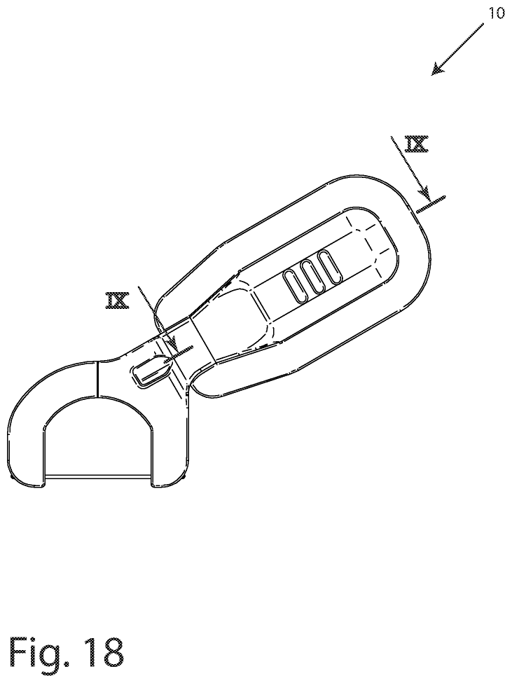

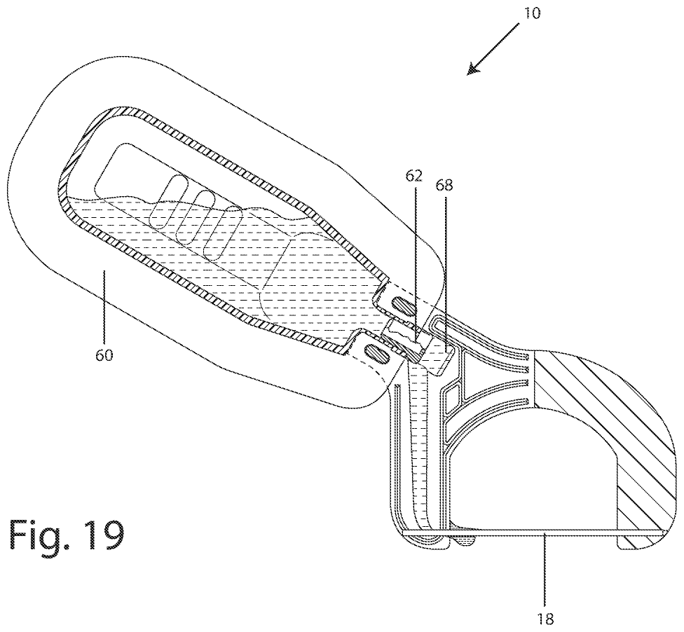

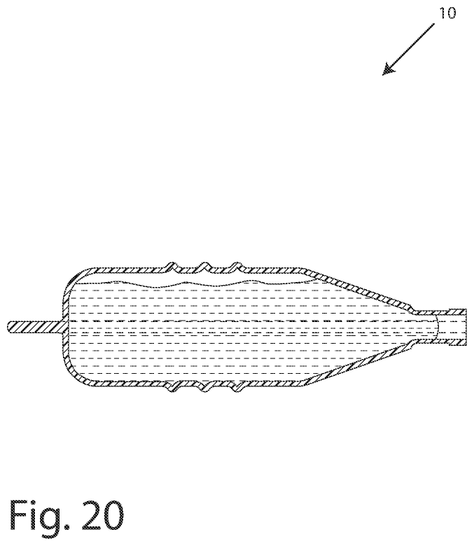

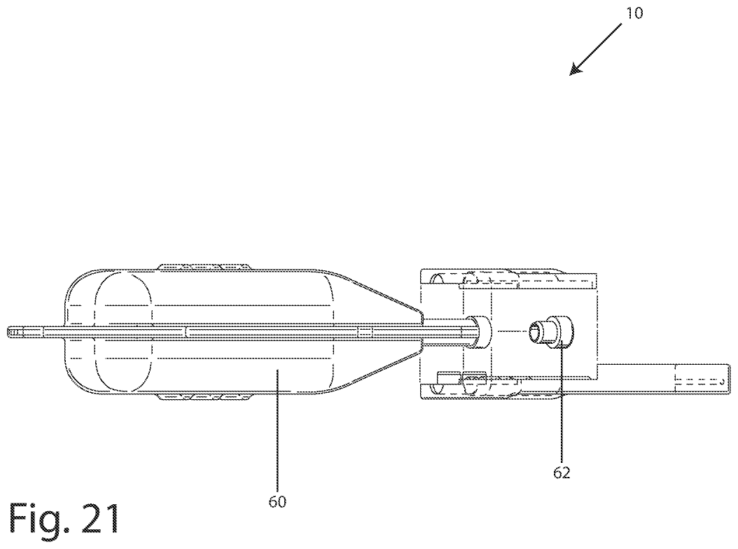

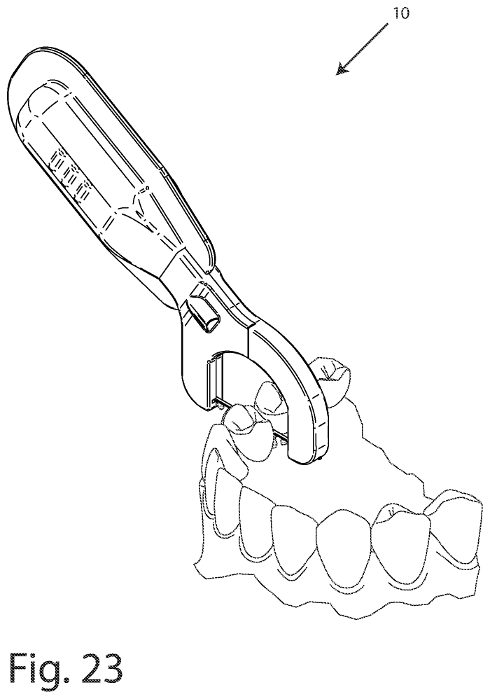

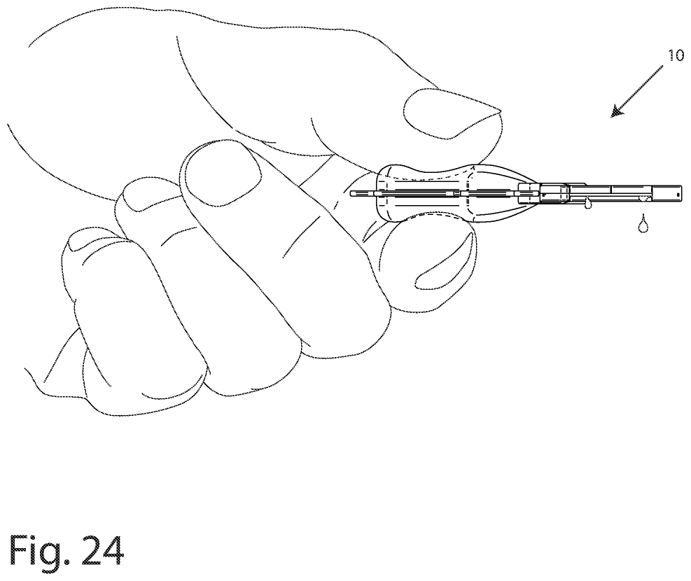

Referring now to FIGS. 12-24, an alternative embodiment of dental apparatus 10, is shown for use in association with, for example, a user's mouth. When applicable and for purposes of avoiding prolix, it will be understood that like or analogous elements and/or components shown in FIGS. 12-24 will be identified with the same reference characters as in FIGS. 1-11.

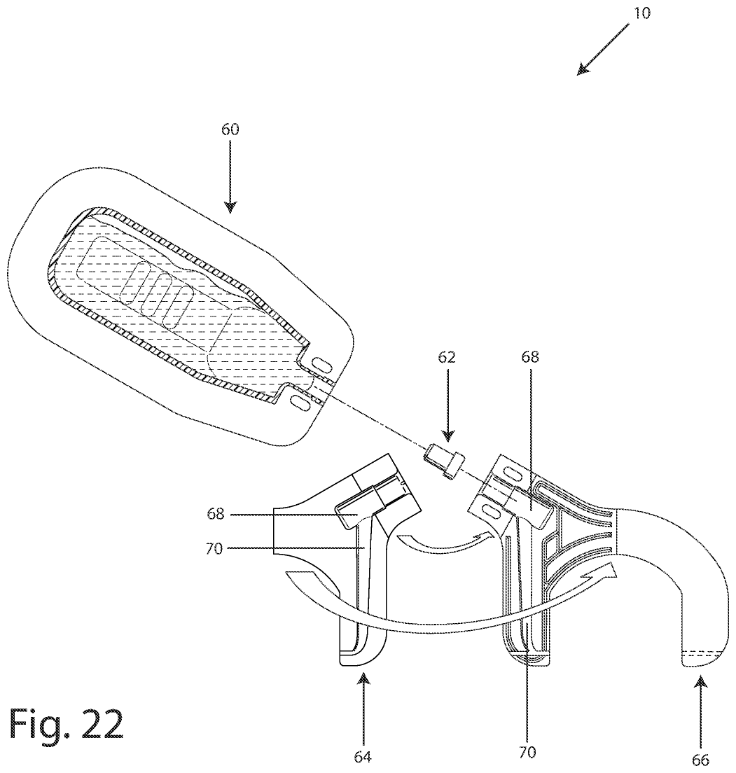

As is best shown in FIG. 22, in this embodiment, dental apparatus 10 preferably includes four components, namely first component 60 (i.e., grippable body member with a fluid reservoir), second component 62 (i.e., reservoir plug), third component 64, (i.e., first armed flossing component), and fourth component 66 (i.e., second armed flossing component). First component 60 is fabricated from a flexible, elastic and/or rubberized material that is readily compressible by the fingers of a user. Such compression enables the displacement of second component 62 into plug reservoir 68 such that fluid is displaced onto the floss held by third and fourth components 64 and 66, respectively. Second component 62 is preferably a plastic, rubber and/or silicone plug. Third component 64 and fourth component 66 are preferably fabricated from a non-elastomeric material, such as a nylon or plastic. All four component are associable via conventional compression and/or adhesion. Third component 64 and fourth component 66 include fluid channel 70.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by Letters Patent of the United States is:

1. A dental apparatus that enables a user to controllably dispense one or more fluids during normal operation, comprising:
a first component, wherein the first component includes a body having a fluid reservoir;
a second component, wherein the second component includes a displaceable plug;
a third component and a fourth component, wherein the third and fourth components collectively include a plug reservoir and a fluid delivery channel.
